(19) United States
(12) Patent Application Publication
(10) Pub. No.: US 2025/0244717 A1
(43) Pub. Date: Jul. 31, 2025

(54) TIMEPIECE CONTROL DEVICE

(71) Applicant: ROLEX SA, Geneva (CH)

(72) Inventor: Pierre-Alain Graemiger, Trélex (CH)

(73) Assignee: ROLEX SA, Geneva (CH)

(21) Appl. No.: 19/037,704

(22) Filed: Jan. 27, 2025

(30) Foreign Application Priority Data
Jan. 29, 2024 (EP) 24154535.9

(51) Int. Cl. G04B 19/25; G04B 27/02

(52) U.S. Cl. CPC G04B 19/25; G04B 27/02

(57) ABSTRACT

The timepiece control device (100) for a timepiece movement (200) has a frame (99), a control stem (1) having an axis (A1), a first pinion (4) that can be actuated in rotation by the control stem (1) and is adapted to be connected to at least one first mechanism (80, 70), in particular at least one first mechanism (80, 70) for correction of an indicator member, and a second pinion (6) that can be actuated in rotation by the control stem (1) and is adapted to be moved axially both relative to the control stem (1) and relative to the frame (99) and to be connected to a second mechanism (90), in particular a winding mechanism (90).

### CROSS-REFERENCE TO RELATED APPLICATION

This application claims priority of European patent application No. EP24154535.9 filed Jan. 29, 2024, the content of which is hereby incorporated by reference herein in its entirety.

### FIELD OF THE INVENTION

The invention concerns a timepiece control device for a timepiece movement. The invention also concerns a timepiece movement comprising such a timepiece control device. The invention further concerns a timepiece comprising such a timepiece movement or such a timepiece control device. The invention finally concerns a method of operating such a timepiece movement or such a timepiece or such a timepiece control device.

### BACKGROUND ART

The patent application EP1152303 describes a mechanism that can be actuated by a control stem on which are mounted a single sliding pinion constrained to rotate with the control stem and a winder pinion mounted to rotate freely on said control stem. In a first axial position the control stem actuates the winding mechanism by means of rear teeth of the sliding pinion that act on front teeth of the winding pinion. In its second axial position the control stem drives the date and day correction mechanism, also by means of the rear teeth of the sliding pinion that act on the front teeth of the winding pinion. In its third axial position the control stem actuates the hour correction mechanism by means of front teeth of the sliding pinion. This mechanism makes it possible to eliminate the risk of unintentional correction of the date or the day of the week during movement from the first axial position of the stem to the second. However, it has the disadvantage that it does not eliminate the risk of jamming during the passage from the first axial position of the stem to the second if the winding chain is under tension.

The patent application CH432389 describes a mechanism that can be actuated by a control stem on which are mounted a single sliding pinion constrained to rotate with the control stem and a winding pinion also constrained to rotate with said control stem. The switching device enabling passage from a winding function to a correction function of an indicator member is made possible here by the use of two distinct horizontal clutch devices. In particular, the first clutch is dedicated to the winding function and the second is adapted to control the translation of the sliding pinion so as to activate or to deactivate the time-setting kinematic chain. Each clutch includes a bistable lever that is disposed in a plane parallel to that of the frame of the timepiece and that is piloted directly by the pull-out piece. A first position of one or the other of the two levers corresponds to a position of activation of the associated function while a second position corresponds to a deactivation position. Thus it is not possible to add a third function for correction of a second indicator member such as one providing a time-derived indication without fitting an additional clutch device.

The patent EP2724199B1 also describes a mechanism that can be actuated by a control stem on which are mounted a single sliding pinion constrained to rotate with the control stem and a winding pinion also constrained to rotate with said control stem. This mechanism has the particular feature of comprising a winding mechanism actuated by a vertical clutch, in particular by a vertical clutch perpendicular to the axis of longitudinal symmetry of the control stem, while the mechanism for correction of at least one indicator member is actuated by the sliding pinion.

For its part, the application EP3339967A1 is specifically directed to protecting a particular kinematic of the sliding pinion that can be moved in translation relative to the frame in two opposite senses for the same sense of actuation of the control stem, in order to enable correction of at least two distinct indicator members.

### SUMMARY OF THE INVENTION

The aim of the invention is to provide a timepiece control device enabling improvement of the devices known from the prior art. In particular, the invention proposes a timepiece control device that is simple and reliable and the overall size of which, within the thickness of the timepiece movement, is limited.

A timepiece control device according to the invention is defined by point 1 below.
1. A timepiece control device for a timepiece movement, comprising:
   a frame,
   a control stem having an axis,
   a first pinion that can be actuated in rotation by the control stem and is adapted to be connected to at least one first mechanism, in particular at least one first mechanism for correction of an indicator member, and
   a second pinion that can be actuated in rotation by the control stem and is adapted to be moved axially both relative to the control stem and relative to the frame and to be connected to a second mechanism, in particular a winding mechanism.

Embodiments of the timepiece control device are defined by points 2 to 14 below.
2. The timepiece control device as defined in point 1, wherein the first pinion is a pinion adapted to be moved axially both relative to the control stem and relative to the frame.
3. The timepiece control device as defined in point 2, wherein the timepiece control device comprises a first lever and a pull-out piece and in that the first pinion is adapted to be actuated in translation by the first lever, itself actuated by the pull-out piece piloted by the effect of the translation of the control stem.
4. The timepiece control device as defined in the preceding point, wherein the pull-out piece comprises a first shape adapted to act by contact on the first lever, in particular on a flank of the first lever.
5. The timepiece control device as defined in point 3 or 4, wherein the device comprises a first element for biasing the first lever against the pull-out piece.
6. The timepiece control device as defined in any one of the preceding points, wherein the timepiece control device comprises a second lever and a pull-out piece and the second pinion is adapted to be actuated in translation by the second lever, itself actuated by the pull-out piece piloted by the effect of the translation of the control stem.
7. The timepiece control device as defined in the preceding point, wherein the pull-out piece comprises a second shape adapted to act by contact on the second lever, in particular on a flank of the second lever.
8. The timepiece control device as defined in point 6 or 7, wherein the device comprises a second element for biasing the second lever against the pull-out piece.
9. The timepiece control device as defined in any one of the preceding points and in points 3 and 6, wherein the first shape of the pull-out piece and the first lever are disposed in the same first plane and the second shape of the pull-out piece and the second lever are disposed in a second plane parallel to the first plane.
10. The timepiece control device as defined in any one of the preceding points, wherein the first or second pinion, in particular the first pinion, comprises first teeth and second teeth, the first teeth being adapted to actuate a first correction mechanism and the second teeth being adapted to actuate a second correction mechanism.
11. The timepiece control device as defined in any one of the preceding points, wherein the second pinion comprises teeth adapted to actuate a third mechanism, in particular a winding mechanism, by means of a winding pinion mounted to rotate freely on the control stem.
12. The timepiece control device as defined in any one of the preceding points, wherein the device is such that the control stem has three stable positions relative to the frame:
   a first position for winding,
   a second position for correction of at least one indication, such as a calendar indication, in particular bidirectional correction of the at least one indication depending on the sense of rotation of the control stem or correction of two distinct indications depending on the sense of rotation of the control stem, and
   a time-setting third position.
13. The timepiece control device as defined in any one of the preceding points, wherein the first pinion and/or the second pinion are mounted on the control stem.
14. The timepiece control device as defined in any one of the preceding points, wherein the first pinion includes a non-circular, in particular square, opening cooperating with a complementary shape, in particular a complementary square shape, of the control stem and/or the second pinion includes a non-circular, in particular square, opening cooperating with a complementary shape, in particular a square shape, of the control stem.

A timepiece movement according to the invention is defined by point 15 below.
15. A timepiece movement comprising a timepiece control device as defined in any one of the preceding points.

A timepiece according to the invention is defined by point 16 below.
16. A timepiece, in particular a wristwatch, comprising a timepiece control device as defined in any one of points 1 to 14 and/or a timepiece movement as defined in the preceding point.

An operating method according to the invention is defined by point 17 below.
17. A method of operating a timepiece control device as defined in any one of points 1 to 14 and/or a timepiece movement as defined in point 15 and/or a timepiece as defined in point 16, wherein it comprises:
   in a first position of the control stem, activation of the second pinion depending on the axial position of said second pinion along the axis and deactivation of the first pinion depending on the axial position of said first pinion along the axis, and
   in a second position of the control stem, deactivation of the second pinion depending on the axial position of said second pinion along the axis and first activation of the first pinion depending on the axial position of said first pinion along the axis, and
   in a third position of the control stem, deactivation of the second pinion depending on the axial position of said second pinion along the axis and second activation of the first pinion depending on the axial position of said first pinion along the axis.

### BRIEF DESCRIPTION OF THE DRAWINGS

The appended drawings represent by way of example one embodiment of a timepiece according to the invention.

FIG. 1 is a view of one embodiment of a timepiece according to the invention, a control device being seen from above.

FIG. 2 is a view of one embodiment of a timepiece according to the invention, the control device being seen from below.

FIG. 3 is a view of the control device in section on the longitudinal axis of the stem, the control device being in a first configuration.

FIG. 4 is a view of the underside of the control device in the first configuration.

FIG. 5 is a view of the upper side of the control device in a second configuration.

FIG. 6 is a perspective view of the underside of the control device in the second configuration.

FIG. 7 is a view of the control device in section on the longitudinal axis of the stem, the control device being in the second configuration.

FIG. 8 is a view of the upper side of the control device in a third configuration.

FIG. 9 is a perspective view of the underside of the control device in the third configuration.

FIG. 10 is a view of the control device in section on the longitudinal axis of the stem, the control device being in the third configuration.

### DETAILED DESCRIPTION OF PARTICULAR EMBODIMENTS

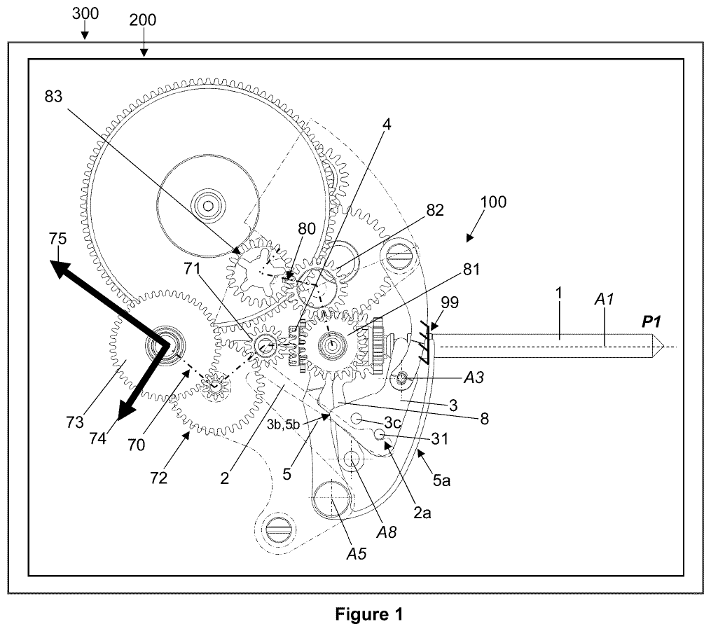

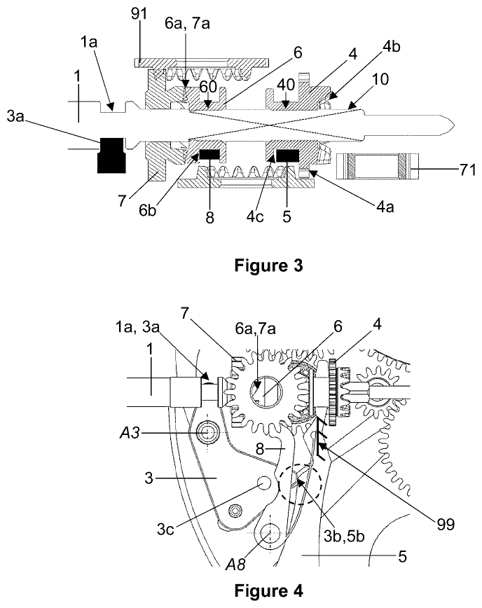

One embodiment of a timepiece 300 is described in detail hereinafter with reference to FIGS. 1 to 10.

The timepiece 300 is for example a watch, in particular a wristwatch. The timepiece 300 comprises a timepiece movement 200 intended to be mounted in a timepiece case in order to protect it from the exterior environment.

The timepiece movement 200 is a mechanical movement, in particular an automatic movement, or a hybrid movement or an electronic movement.

The timepiece movement 200 comprises a timepiece control device 100 enabling:
selection of different timepiece functions, and
adjustment of timepiece functions or correction of said timepiece functions or action on said timepiece functions.

The timepiece control device 100 comprises:
a frame 99, and
a control stem 1.

The control stem 1 is mobile along its longitudinal axis A1 and relative to the frame 99:
in rotation, and
in translation.

The timepiece functions are preferably selected by translation of the control stem along its longitudinal axis A1 and relative to the frame 99 and/or adjustment of those timepiece functions or correction of those timepiece functions or the action of those timepiece functions is effected by rotation of the control stem about its longitudinal axis A1 relative to the frame 99.

The timepiece control device 100 further comprises:
a first pinion 4 rotation of which can be actuated by the control stem 1 and that is adapted to come into connection with at least one first mechanism 80, 70, in particular at least one first mechanism 80, 70 for correction of an indicator member, and
a second pinion 6 rotation of which can be actuated by the control stem 1 and that is adapted to be moved axially both relative to the control stem 1 and relative to the frame 99 and to come into connection with a second mechanism 90, in particular a winding mechanism 90.

The first pinion 4 may be a sliding pinion actuated in translation by a first lever 5 itself actuated by a pull-out piece 3 driven by the translation of the control stem 1. The second pinion 6 is advantageously a sliding pinion actuated in translation by a second lever 8 itself actuated by the same pull-out piece 3 that actuates the first lever 5.

The timepiece control device is operated by the control stem 1 adapted to be disposed in three axial positions P1, P2, P3. These positions are defined thanks to a spring 2 that acts on the positioning of the pull-out piece 3 pivoting about an axis A3 relative to the frame 99. In particular, the spring 2 includes a beak 2a that cooperates with a pin 31 of the pull-out piece. The beak 2a is conformed to define three notches. The pull-out piece 3 is connected to the control stem 1 by means of a post 3a engaged in a groove 1a in the control stem 1.

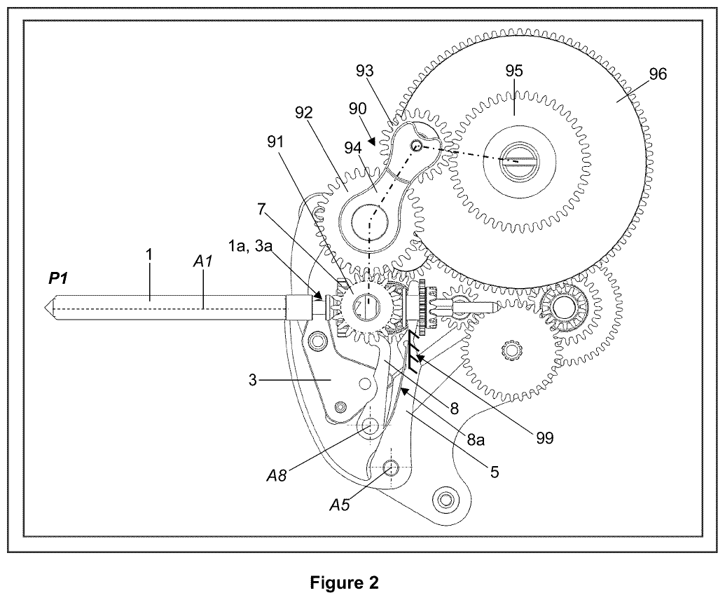

FIGS. 1 and 2 are respectively views from above and from below of the timepiece control device 100 with a control stem 1 in position P1.

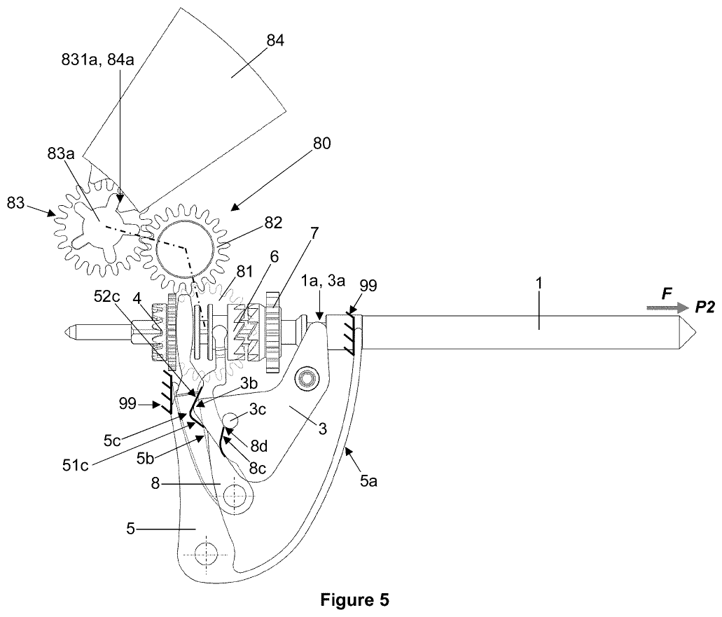

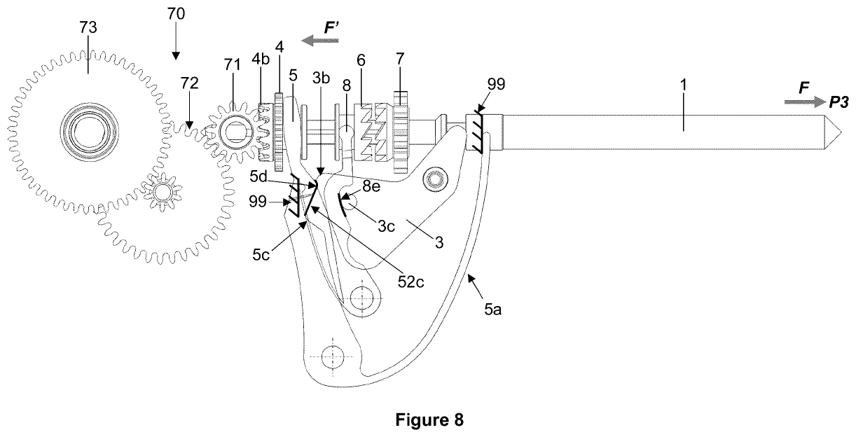

In the embodiment described the timepiece control device 100 is adapted to enable winding of the movement 200 and to enable correction of a first indicator member and at least one second indicator member depending on the position of the stem. In particular:
In position P1, as represented in FIGS. 1 to 4, the control stem 1 is adapted to be connected kinematically to a winding mechanism 90 of the movement 200. In particular, rotation of the control stem 1 in a given sense winds the barrel of the movement 200.
In position P2, as represented in FIGS. 5 to 7, the control stem 1 is kinematically connected to a mechanism 80 for correction of a first indicator member, such as a calendar disc, in particular a date disc driven by the movement 200. Thus, rotation of the control stem 1 enables correction, in particular incremental correction, of a date disc.
In position P3, as represented in FIGS. 8 to 10, the control stem 1 is kinematically connected to a mechanism 70 for correction of a second indicator member, such as hour and minute hands driven by the movement 200. Thus rotation of the control stem 1 adjusts the hour and minute hands.

The control stem 1 carries out these various correction or adjustment functions by means of the first sliding pinion 4, which is constrained to rotate with it. Advantageously, the first pinion 4 is mounted on the control stem 1, in particular the first pinion 4 is mounted directly on the control stem. This pinion 4 has to this end an axial opening 40 with non-circular geometry (a non-circular cross section) mounted on a portion 10 with complementary geometry of the control stem (an additional non-circular cross section). In particular, here the opening 40 of the pinion 4 has a square shape, adapted to cooperate with a square 10 formed on the control stem 1. This pinion 4 has sets of teeth 4a, 4b that are respectively adapted to actuate the correction mechanisms 80 and 70 depending on the position of the first lever 5 pivoting about an axis A5 and one end of which is engaged in a groove 4c on the pinion 4.

For its part, the winding function may be effected by means of the second sliding pinion 6 constrained to rotate with the stem which is adapted to mesh with a winding pinion 7 mounted freely on the control stem 1 depending on the position of the second lever 8 pivoting about an axis A8 and one end of which is engaged in a groove 6b on the pinion 6.

Advantageously, the second pinion 6 is mounted on the control stem 1, in particular the second pinion 6 is mounted directly on the control stem. Like the pinion 4, this pinion 6 advantageously has a non-circular axial opening 60 (a non-circular cross section) mounted on the portion 10 with a complementary section of the control stem 1 (an additional non-circular cross section). In particular, here the opening 60 in the pinion 6 has a square shape, adapted to cooperate with a square 10 formed on the control stem.

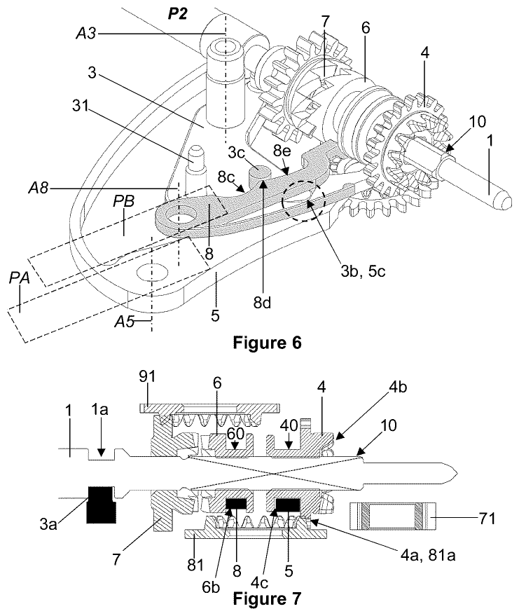

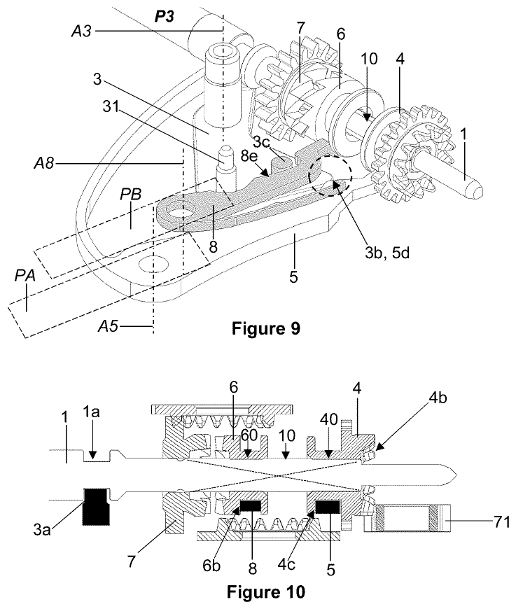

As seen more particularly in FIGS. 6 and 9, here levers 5 and 8 are disposed in two distinct and parallel planes. In particular, the lever 5 takes the form of a plane component while the lever 8 is staggered at its end cooperating with the groove 6b on the pinion 6. The ends of the levers 5 and 8 respectively cooperating with the grooves 4c and 6b of the pinions 4 and 6, disposed coaxially with the stem, are therefore disposed in the same plane.

In position P1, the second lever 8 presses Breguet teeth 6a of the sliding pinion 6 against Breguet teeth 7a of the winding pinion 7 because of the effect of a return spring 8a here made in one piece with the lever 8, the return spring 8a biasing the second lever 8 against the pull-out piece 3. The control device can therefore comprise a second element 8a for biasing the second lever 8. This biasing element 8a may in particular form part of the lever 8.

Consequently, rotation of the control stem 1 in a first sense winds the barrel 96 via the winding chain type winding mechanism 90. In particular, this winding chain comprises:
a winding crown 91 engaged with the winding pinion 7,
a wheel 92,
a pinion 93, and
a ratchet 95.

The wheel 92 and the pinion 93 preferably pivot on a conventional winding lever 94.

In position P1, the pull-out piece 3 has no effect on the lever 8, which is positioned exclusively by its return spring 8a bearing on the frame 99 of the timepiece movement. In this same position P1, the pinion 4 is out of reach of the wheels forming part of the correction mechanisms 80 and 70 thanks to the lever 5, itself positioned by the pull-out piece 3, in particular by a flank 3b of the pull-out piece 3 that acts on a portion 5b of the lever 5 against the action of a return spring 5a bearing against the frame 99. The control device can therefore comprise a first element 5a for biasing the first lever 5 against the pull-out piece 3. This return element 5a may in particular form part of the lever 5.

Pulling the control stem 1 outwardly of the timepiece movement from position P1 (in the sense of the arrow F depicted in FIG. 5) causes the latter to move to position P2. During this manipulation, a stud 3c or any other shape projecting from the pull-out piece 3 acts against a flank 8c of the lever 8 until it reaches its top 8d, which causes movement of the pinion 6 away from the winding pinion 7. During this same manipulation, the flank 3b of the pull-out piece 3 is disengaged from the portion 5b of the lever 5 and comes to be accommodated in a depression 5c formed by walls 51c and 52c (depicted in bold in FIG. 5). The lever 5 is therefore biased in the sense of the arrow F by its spring 5a and thus generates the meshing of the teeth 4a of the pinion 4 with teeth 81a of a ring 81 for correction of the date, as represented in FIG. 7.

Thus, in position P2, the pinion 6 is out of reach of the winding pinion 7 and so the rotation of the control stem 1 has no effect on the winding mechanism. In this same position, the teeth 4a of the pinion 4 are engaged with the teeth 81a of the ring 81, and so the rotation of the control stem 1 corrects the date. To this end, the ring 81 is engaged with a corrector mobile 83 by means of an intermediate wheel 82. In particular, here the mobile 83 comprises a corrector 83a the teeth 831a of which are adapted to act on the teeth 84a of a date disc 84 because of the rotation of the control stem 1. Here this correction is effected in both senses thanks to a mobile 83 pivoting on the frame 99. It is naturally entirely possible to imagine other correction modes. For example, the corrector mobile could pivot on a lever or in an oblong cut-out in particular formed on the frame of the timepiece movement so as to enable correction in only one sense of rotation of the control stem 1. Additionally or alternatively, the corrector mobile could enable correction of other information such as day of the week information.

Pulling the control stem 1 outwardly from the movement from the position P2 (in the sense of the arrow F depicted in FIG. 8) causes the latter to go to position P3. During this manipulation the stud 3c acts against a flank 8e of the lever 8 that is shaped so as to retain said lever 8 in the same axial position and thus to maintain the pinion 6 out of reach of the winding pinion 7. During this same manipulation, the flank 3b of the pull-out piece 3 is disengaged from the depression 5c, moving along the wall 52c until it reaches its top 5d, which causes translation of the pinion 4 toward the interior of the movement (in the sense of the arrow F′ depicted in FIG. 8) until it enables meshing of its teeth 4b with the time-setting intermediate wheel 71. This intermediate wheel 71 is engaged with an hour wheel 73 and a cannon pinion (not represented) by means of an intermediate mobile 72. Rotation of the control stem 1 in position P3 therefore causes rotation of the hour hand 74 and the minute hand 75 respectively fastened to the hour wheel and the cannon pinion wheel.

As a consequence of what has been described above, the first pinion 4 is advantageously adapted to be actuated in translation by the first lever 5, itself actuated by the pull-out piece 3 driven by the translation of the control stem 1.

As a consequence of what has been described above, the second pinion 6 is advantageously adapted to be actuated in translation by the second lever 8, itself actuated by the pull-out piece 3 driven by the translation of the control stem 1.

The first pinion is not necessarily a sliding pinion. It can for example have a single axial position (relative to the frame 99) whatever the axial position of the control stem 1. Assuming this is the case, various ancillary levers enable clutch engagement and clutch disengagement of the various functions for correction or adjustment of the movement, while the first pinion has a single axial position relative to the frame. Assuming this is the case or assuming a sliding pinion, the first pinion is permanently constrained to rotate with the stem. Furthermore, the first pinion 4 is directly driven in rotation by the control stem, that is to say without the intermediary of an auxiliary part. In particular, the first pinion 4 may be connected to the control stem 1 by a sliding connection.

As a further alternative, the first pinion may be fixed or connected by setting to the control stem 1. Assuming this is the case, the movements in translation of the control stem enable engagement or disengagement of teeth of the first pinion and teeth of at least one first mechanism 80, 70, in particular at least one first mechanism 80, 70 for correction of an indicator member, in particular engaging or disengaging teeth of the first pinion and teeth of a first mechanism and engaging or disengaging teeth of the first pinion and teeth of a second mechanism.

As a further alternative, the pull-out piece 3 could for example take the form of an assembly of two components adapted to be movable relative to one another, in particular to facilitate insertion of the stem 1 into the movement or its removal therefrom.

Whatever the embodiment or variant, the second pinion 6 is advantageously permanently constrained to rotate with the control stem. Furthermore, the second pinion 6 is directly driven in rotation by the control stem, that is to say without the intermediary of an auxiliary part. In particular, the second pinion 6 may be connected to the control stem 1 by a sliding connection.

Whatever the embodiment or the variant, the first shape 3b of the pull-out piece 3 and the first lever 5 are preferably disposed in the same first plane PA and the second shape 3c of the pull-out piece 3 and the second lever 8 are preferably disposed in a second plane PB parallel to the first plane.

In the above description, the pinions 4 and 6 are disposed coaxially. Although this embodiment is particularly advantageous, it would nevertheless be possible to conceive of embodiments in which these pinions are parallel, for example in the situation of a mechanism with an offset control stem 1.

In the present document, by “sliding pinion” is meant a pinion movable in translation both relative to the stem and relative to the frame of the movement.

One way of executing an operating method of the timepiece control device 100 described above and/or the timepiece movement 200 described above and/or the timepiece 300 described above is described in detail hereinafter.

The method comprises:
in a first position P1 of the control stem 1, activation of the second pinion 6 depending on the axial position of said second pinion along the axis A1 and deactivation of the first pinion 4 depending on the axial position of said first pinion along the axis A1, and
in a second position P2 of the control stem 1, deactivation of the second pinion 6 depending on the axial position of said second pinion along the axis A1 and first activation of the first pinion 4 depending on the axial position of said first pinion along the axis A1, and
in a third position P3 of the control stem 1, deactivation of the second pinion 6 depending on the axial position of said second pinion along the axis A1 and second activation of the first pinion 4 depending on the axial position of said first pinion along the axis A1.

By “activation of a pinion” is meant that the pinion is configured to transmit movement to a mechanism (in particular a correction, adjustment or winding mechanism) as a consequence of rotation of the control stem 1.

By “deactivation of a pinion” is meant that the pinion is in a configuration such that it does not transmit movement to a mechanism (in particular a correction, adjustment or winding mechanism) as a consequence of rotation of the control stem 1.

The second position P2 and the third position P3 of the control stem are different. In the second position P2 and the third position P3 of the control stem 1 the axial positions of the first pinion 4 are different.

The solutions described above are distinguished in particular by the use of a clutch in the plane of the movement enabling winding, made possible thanks to a second sliding pinion, which can advantageously be substituted for a vertical clutch. Such a design has the advantage of proposing a compact mechanism that can be integrated into a particularly thin timepiece movement while retaining the operating advantages of a timepiece control device with no jamming or untimely adjustment during the manipulation of the control stem, in particular during the movement from one to another of the various axial positions of the control stem.

In particular, in accordance with the solutions described above, a sliding pinion is dedicated exclusively to engagement of the winding mechanism, in particular by means of a winding pinion mounted to rotate freely about the control stem. The engagement of the winding mechanism is therefore effected about the longitudinal axis of the control stem or an axis parallel to the longitudinal axis of the control stem in the plane of the movement.

The invention claimed is:

1. A timepiece control device for a timepiece movement, comprising:
a frame,
a control stem having an axis,
a first pinion that can be actuated in rotation by the control stem and is adapted to be connected to at least one first mechanism, and
a second pinion that can be actuated in rotation by the control stem and is adapted to be moved axially both relative to the control stem and relative to the frame and to be connected to a second mechanism.

2. The timepiece control device as claimed in claim 1, wherein the first pinion is a pinion adapted to be moved axially both relative to the control stem and relative to the frame.

3. The timepiece control device as claimed in claim 2, wherein the timepiece control device comprises a first lever and a pull-out piece and wherein the first pinion is adapted to be actuated in translation by the first lever, the first lever being actuated by the pull-out piece piloted by an effect of the translation of the control stem.

4. The timepiece control device as claimed in claim 3, wherein the pull-out piece comprises a first shape adapted to act by contact on the first lever.

5. The timepiece control device as claimed in claim 3, wherein the device comprises a first element for biasing the first lever against the pull-out piece.

6. The timepiece control device as claimed in claim 1, wherein the timepiece control device comprises a second lever and a pull-out piece, and wherein the second pinion is adapted to be actuated in translation by the second lever, the second lever being actuated by the pull-out piece piloted by an effect of the translation of the control stem.

7. The timepiece control device as claimed in claim 6, wherein the pull-out piece comprises a second shape adapted to act by contact on the second lever.

8. The timepiece control device as claimed in claim 6, wherein the device comprises a second element for biasing the second lever against the pull-out piece.

9. The timepiece control device as claimed in claim 1,
wherein the timepiece control device comprises a first lever and a pull-out piece,
wherein the first pinion is adapted to be actuated in translation by the first lever, the first lever being actuated by the pull-out piece piloted by an effect of the translation of the control stem,
wherein the timepiece control device comprises a second lever and a pull-out piece,
wherein the second pinion is adapted to be actuated in translation by the second lever, the second lever being actuated by the pull-out piece piloted by an effect of the translation of the control stem, and
wherein the first shape of the pull-out piece and the first lever are disposed in a first plane and the second shape of the pull-out piece and the second lever are disposed in a second plane parallel to the first plane.

10. The timepiece control device as claimed in claim 1, wherein the first or second pinion comprises first teeth and second teeth, the first teeth being adapted to actuate a first correction mechanism and the second teeth being adapted to actuate a second correction mechanism.

11. The timepiece control device as claimed in claim 1, wherein the second pinion comprises teeth adapted to actuate a third mechanism by means of a winding pinion mounted to rotate freely on the control stem.

12. The timepiece control device as claimed in claim 1, wherein the control stem has three stable positions relative to the frame, wherein the three stable positions are:
a first position for winding,
a second position for correction of at least one indication, and
a time-setting third position.

13. The timepiece control device as claimed in claim 1, wherein
the first pinion is mounted on the control stem, and/or
the second pinion is mounted on the control stem.

14. The timepiece control device as claimed in claim 1, wherein
the first pinion includes a non-circular opening cooperating with a complementary shape of the control stem, and/or
the second pinion includes a non-circular opening cooperating with a complementary shape of the control stem.

15. A timepiece movement comprising the timepiece control device as claimed in claim 1.

16. A timepiece comprising the timepiece control device as claimed in claim 1.

17. A method of operating the timepiece control device as claimed in claim 1, wherein the method comprises:
in a first position of the control stem, activating the second pinion depending on an axial position of the second pinion along the axis and deactivating the first pinion depending on an axial position of the first pinion along the axis,
in a second position of the control stem, deactivating the second pinion depending on the axial position of the second pinion along the axis and performing a first activation of the first pinion depending on the axial position of the first pinion along the axis, and
in a third position of the control stem, deactivating the second pinion depending on the axial position of the second pinion along the axis and performing a second activation of the first pinion depending on the axial position of the first pinion along the axis.

18. The timepiece control device as claimed in claim 1, wherein the first mechanism is a mechanism for correction of an indicator member.

19. The timepiece control device as claimed in claim 18, wherein the second mechanism is a winding mechanism.

20. The timepiece control device as claimed in claim 11, wherein the third mechanism is a winding mechanism.
